(19) United States
(12) Patent Application Publication
(10) Pub. No.: US 2018/0194297 A1
(43) Pub. Date: Jul. 12, 2018

(54) SPORT BAR MOUNTING SYSTEM FOR USE WITH BED COVERS

(71) Applicant: Iddea California, LLC, Brea, CA (US)

(72) Inventor: Timothy J. Wymore, Yorba Linda, CA (US)

(21) Appl. No.: 15/912,052

(22) Filed: Mar. 5, 2018

Related U.S. Application Data
(63) Continuation of application No. 15/331,344, filed on Oct. 21, 2016.

(51) Int. Cl. B60R 11/00; B62D 39/00; B62D 27/02; B60J 7/06; B60J 7/10

(52) U.S. Cl. CPC B60R 11/00; B62D 39/00; B60R 2011/005; B60J 7/068; B60J 7/102; B62D 27/02

(57) ABSTRACT

A sport bar is disclosed. The sport bar includes a mounting bracket on either side of the sport bar. Each mounting bracket has a substantially squared C shaped cross section, with parts, a top plate, a side wall, and a base plate. The top plate is cantilevered over the base plate and attaches to the bars. The base plate attaches to a top rail of the side walls of the pickup bed.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Sport bars generally mount on the top rails of the opposing side walls of a pickup bed, and allow for the use of tonneau covers which mount to the inside surface of the opposing side walls of the pickup bed. Tonneau covers are generally roll up covers. Roll up covers are generally mounted in a track along a top of the inside surface of the opposing side walls. Known sport bar configurations are not compatible with tonneau covers which mount on the top rails of the side walls of a pickup bed.

Therefore, there is not currently a sport bar which is universally compatible with all tonneau covers.

### BRIEF SUMMARY

The present disclosure includes a sport bar mounting system which mounts a sport bar to the top rail of each of two opposing side walls of a pickup bed. To attach the sport bar, two mounting brackets, which are mirror images of one another, are used. Each mounting bracket is a generally C shaped elongate channel with the interior of the channel sized to receive a tonneau cover therein. To create the C shaped elongate channel, the mounting bracket includes a base plate, which attaches to a top rail of the pickup bed, a side wall which extends upward from the base plate, and a top plate cantilevers from the side wall over the base plate. The space between an interior surface of the top plate, and an interior surface of the base plate, and the side wall, defines an interior for mounting a top-mounted tonneau cover. The mounting bracket thus allows the sport bar mounting system to be used with top mount or inside mount tonneau covers.

The sport bar mounting system may further include removable end panels for each of the mounting brackets.

The sport bar mounting system mounting may be configured such that the side wall of the first mounting bracket is perpendicular to the top plate and base plate of the first mounting bracket, and the side wall of the second mounting bracket is perpendicular to the top plate and base plate of the second mounting bracket.

The sport bar mounting system mounting may be configured such that a joint between the side wall and the top plate of the first mounting bracket forms an obtuse angle and a joint between the side wall and base plate of the first mounting bracket forms an acute angle, and a joint between the side wall and the top plate of the second mounting bracket forms an obtuse angle and a joint between the base plate and the side wall of the second mounting bracket forms an acute angle.

The sport bar mounting system may further include a gasket under each of the base plates.

The sport bar mounting system may further include at least one spacer above each of the top plates.

The sport bar mounting system mounting may be configured such that a hole in each of the spacers and a slot in each of the top plates align to form a common bore.

The sport bar mounting system mounting may be configured such that a hardware hole in each of the gaskets and a hardware hole in each of the base plates align to form a common bore.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a perspective view of the sport bar mounted to a pickup bed;

FIG. 2 shows an exploded view of the sport bar of FIG. 1;

FIG. 3 shows an exploded perspective of the attachment structures of the sport bar of FIG. 1;

FIG. 4 shows a cross sectional view along line 4-4 of FIG. 2;

FIG. 5 shows a perspective view of the sport bar mounted to a pickup with a roll up tonneau cover; and

FIG. 6 shows a perspective view of the sport bar mounted to a pickup with a top mount tonneau cover.

### DETAILED DESCRIPTION

The present disclosure includes a sport bar mounting system which mounts a sport bar to the top rail of each of two opposing side walls of a pickup bed. To attach the sport bar, two mounting brackets, which are mirror images of one another, are used. Each mounting bracket is a generally C shaped elongate channel with the interior of the channel sized to receive a tonneau cover therein. To create the C shaped elongate channel, the mounting bracket includes a base plate, which attaches to a top rail of the pickup bed, a side wall which extends upward from the base plate, and a top plate cantilevers from the side wall over the base plate. The space between an interior surface of the top plate, and an interior surface of the base plate, and the side wall, defines an interior for mounting a top-mounted tonneau cover. The mounting bracket thus allows the sport bar mounting system to be used with top mount or inside mount tonneau covers.

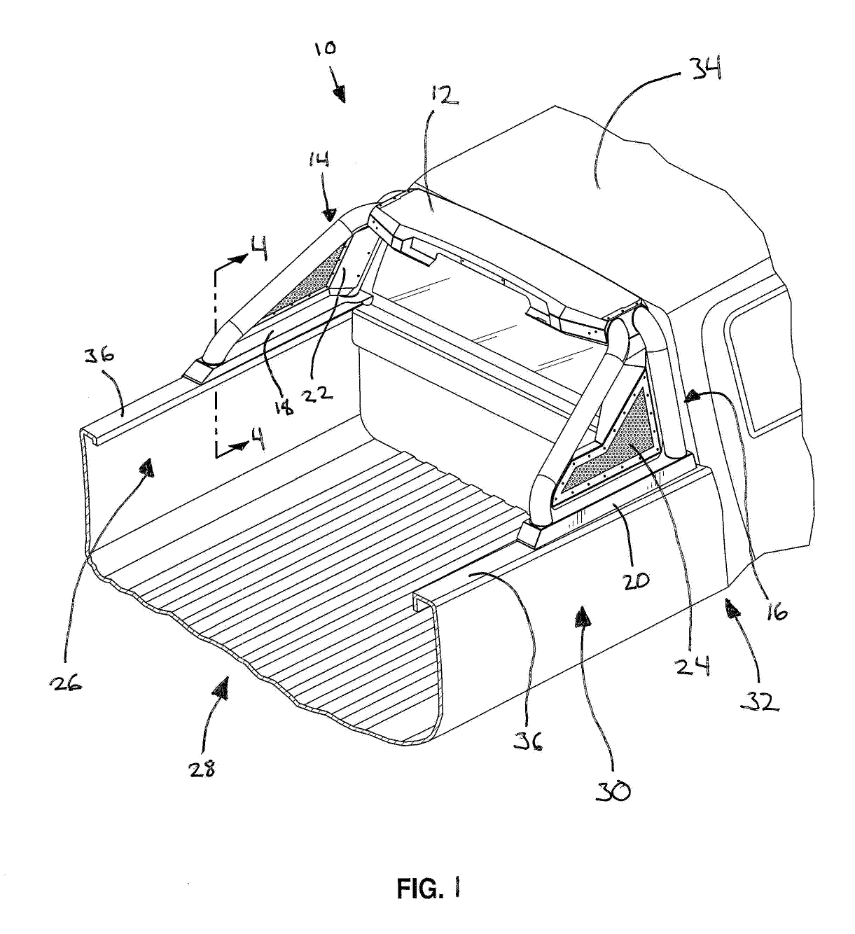

Referring to the drawings, FIG. 1 shows a sport bar and the sport bar mounting system 10. The sport bar includes a crosspiece 12, a first side support 14, a second side support 16. The sport bar mounting system includes a first mounting bracket 18, and a second mounting bracket 20. A first grillwork unit 22 may be mounted in an interior of the first side support 14, and a second grillwork unit 24 may be mounted in an interior of the second side support 16. A first side of the sport bar is mounted to a top rail 36 of a first side wall 26 by the first mounting bracket 18, and a second side of the sport bar is mounted to a top rail 36 second side wall 30 by the second mounting bracket 20. The sport bar is mounted by the sport bar mounting system at a front end 32 of the pickup bed 28, immediately behind the pickup truck cab 34. When mounted, the crosspiece 12 is generally slightly higher than a top of the pickup truck cab 34.

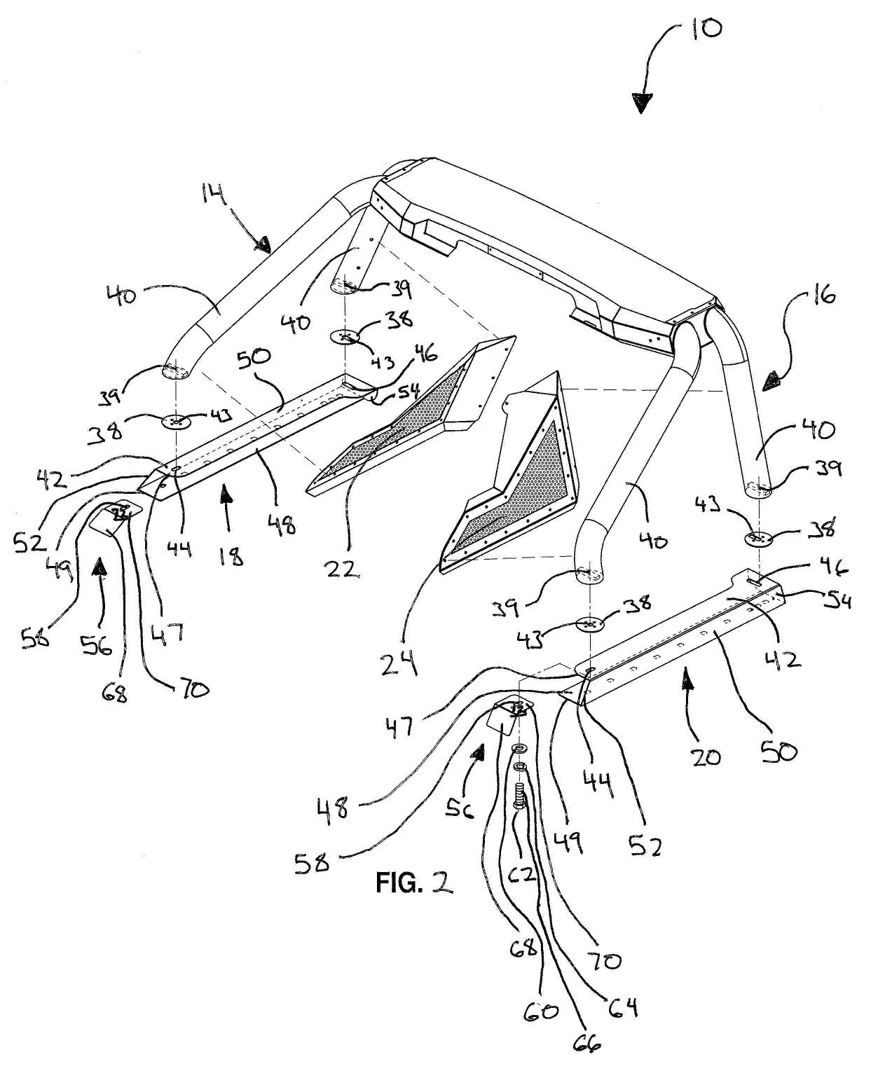

Referring now to FIG. 2 of the drawings, the first grillwork unit 22 and second grillwork unit 24 are shown separated from their respective side supports, 14, 16.

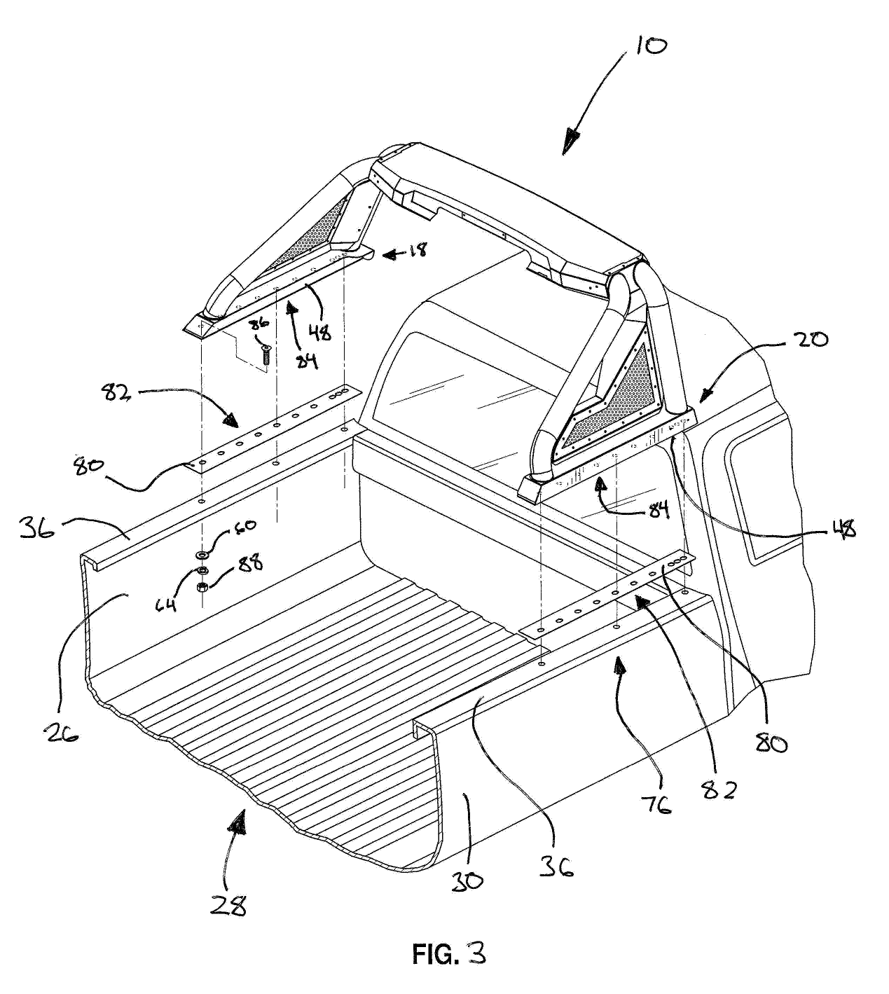

With reference to FIGS. 2-4, the detail of attaching the first mounting bracket 18 and the second mounting bracket 20 to their respective top rails 36 is shown. In this embodiment, the side supports 14, 16, consist of sets of tubes 40. When the side supports are attached to the mounting brackets 18, 20, a spacer 38 is placed between each tube 40 of the side supports 14, 16, and the respective mounting bracket 18, 20. Threaded apertures 39 formed in the end of each of the tubes 40 align with an opening 43 in the center of the spacers 38 to form a common bore. Corresponding slots are formed at either end of each top plate 42 of each of the mounting brackets 18, 20. These slots may be either longitudinal slots 44 with a longitudinal axis parallel to a longitudinal axis of the corresponding mounting bracket 18, 20, or the slots may be perpendicular slots 46 with a longitudinal axis that is perpendicular to the longitudinal axis of the corresponding mounting bracket 18, 20. Each of the slots 44, 46 align with the corresponding opening 43 and threaded aperture 39 to form a common bore.

The ends of the mounting brackets 18, 20 may be angled. That is, the top plate 42 rear edge 47 may be short of the base plate 48 rear edge 49 in a longitudinal direction. The rear edge 52 of the corresponding side wall 50 tapers from the rear edge 47 of the top plate 42 to the rear edge 49 of the base plate 48. Similarly, the front end of the mounting brackets 18, 20 may be angled. The rear end of the mounting bracket 18, 20 may be angled differently than the front end, or the two ends may be angled the same. A front end cap 54 may be integral to the mounting bracket 18, 20.

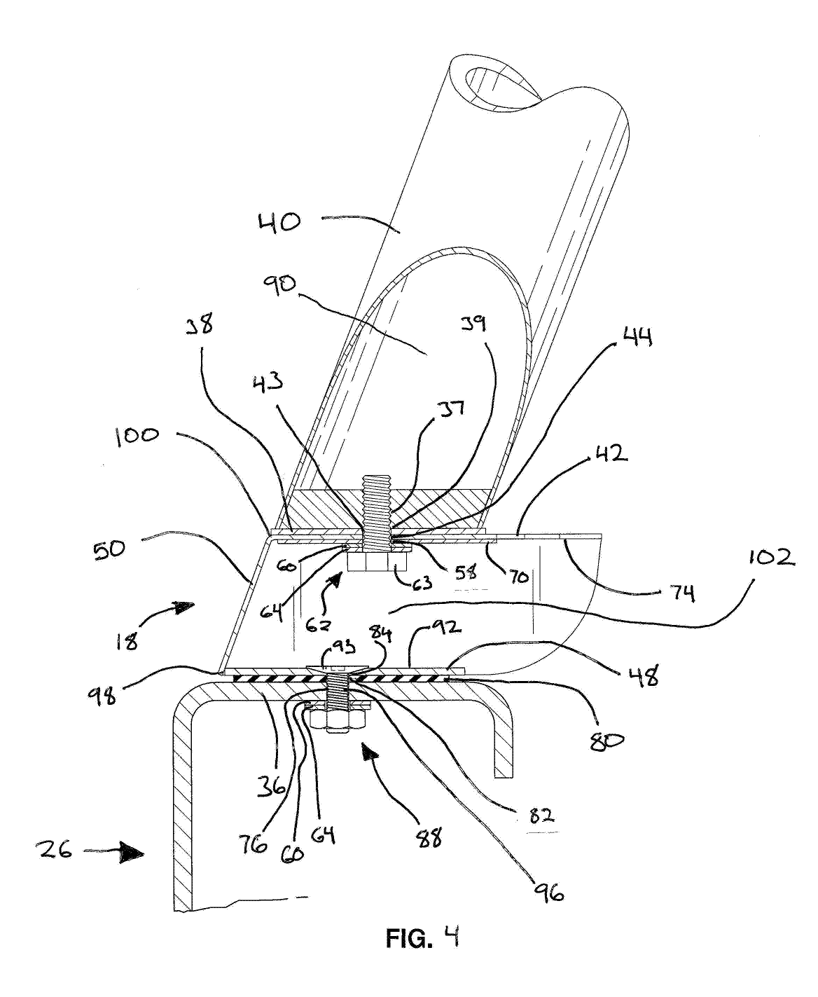

An end panel 56 may be attached to the mounting bracket by a mechanical fastener, for example a bolt 62. The end panel has an angled portion 68 and a horizontal portion 70. A washer 60 or lock washer 64 may be used to ensure that the bolt 62 stays tight. An aperture 58 in the horizontal portion 70 of the end panel 56 may align with the slot 44, the threaded aperture 39, and the opening 43, to form a common bore through which a threaded shank 66 of the bolt 62 may pass. The bolt 62 corresponds to a threaded surface 37 (FIG. 4) of the threaded aperture 39 in the tube 40. The angle of the angled portion 60 matches the taper of the rear edge 52 of the side wall 50 of the mounting bracket 18, 20.

A plurality of attachment point holes 76 are drilled or otherwise made in the top rail 36 in each of the side walls 26, 30 of the pickup bed 28. A mounting base spacer or gasket 80 has a plurality of hardware holes 82 spaced such that at least two of the plurality of hardware holes 82 align with the plurality of attachment point holes 76 to form a common bore. The base plate 48 of the mounting bracket 18, 20 has a plurality of hardware holes 84 which correspond to the plurality of hardware holes 82 in the gasket 80. Together, the plurality of hardware holes 84 of the mounting bracket 18, 20, the plurality of hardware holes 82 of the mounting base spacer 80, and the attachment point holes 76 in the top rails 36 form a common bore for connecting with a mechanical fastener 86. The mechanical fastener 86, may be, for example, a nut and bolt combination 88. A washer 60 or lock washer 64 may optionally be used to ensure that the nut and bolt combination 88 remains tight after it is used to attach the sport bar 10 to the pickup bed 28.

With reference to FIG. 4, a cross section of a portion of the sport bar 10 at line 4-4 in FIG. 2 is shown. The mounting bracket 18, 20 is a generally C shaped elongate channel with the interior of the channel sized to receive a tonneau cover therein. That is, the mounting bracket 18, 20 has a base plate 48 which attaches to one of the top rails 36. Along an outside longitudinal edge 98 of the base plate 48, the base plate 48 is connected to a side wall 50, forming a joint. When in cross section along a longitudinal axis, the side wall 50 may be perpendicular to the base plate 48. Alternatively, the side wall 50 may be inclined inward such that an edge 100 opposite that attached to the outside edge 98 of the base plate 48 is interior of the base plate 48. A top plate 42 attaches to the side wall 50 along the longitudinal edge 100 opposite that which attaches to the base plate 48. The top plate 42 cantilevers from the side wall 50 over the base plate 48. The top plate 42 and base plate 48 are substantially parallel to one another. The space between the opposing top plate 42 and base plate 48 and the side wall 50 defines an interior 102 of the mounting bracket 18, 20, wherein a top mounted bed or tonneau cover may be mounted.

The head 63 of the bolt 62 extends in to an interior 102 of the mounting bracket 18, 20. Alternatively, in order to allow maximum space for a tonneau cover which mounts on the top rail 36 of the side wall 26, 30 of the pickup bed 28, the head 63 may be counter sunk so that a minimum or none of the head 63 extends in the interior of the mounting bracket 18, 20.

A head 93 of the bolt of the nut and bolt combination 88 is countersunk so that the nut and bolt combination 88 presents an even surface with the remainder of an interior surface 92 of the base plate 48 of the mounting bracket 18, 20. The gasket 80 may be placed between the base plate 48 of the mounting bracket 18, 20 and the top rail 36 of the side wall 26, 30 of the pickup bed 28, in order to form a waterproof barrier and prevent metal on metal contact.

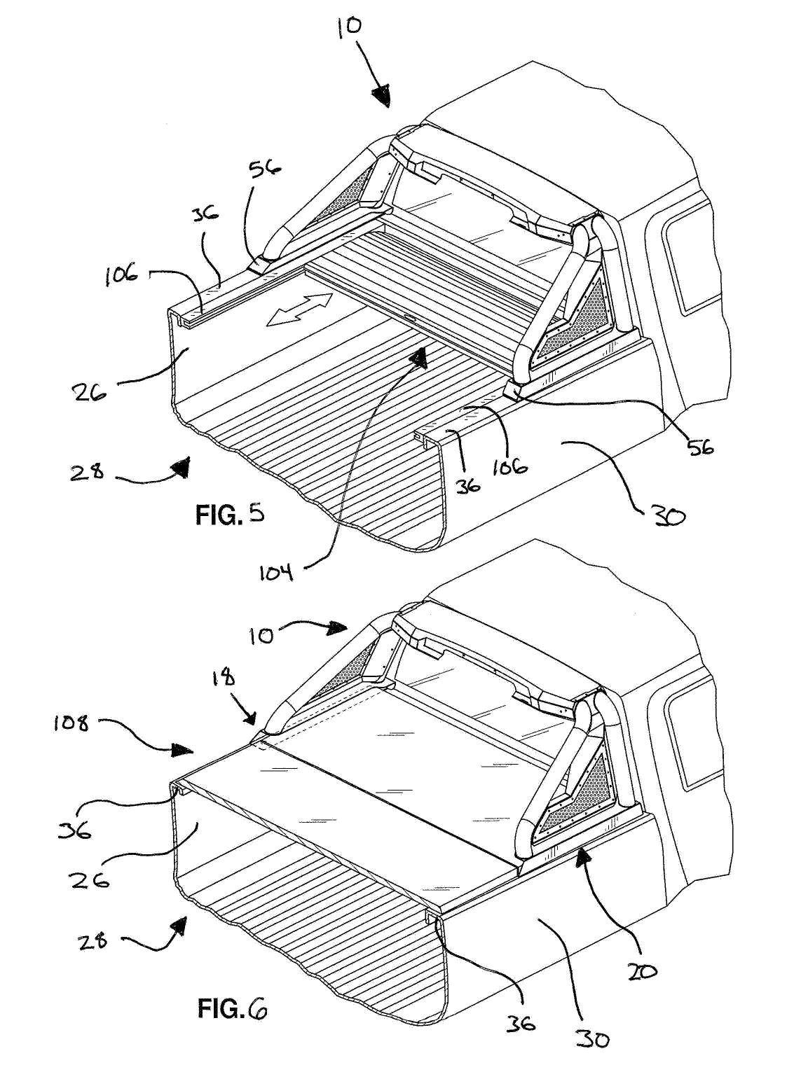

FIG. 5 shows a roll up tonneau cover 104 which mounts to an interior side of each of the side walls 26, 30 of the pickup bed 28. The roll up tonneau cover 104 rides on rails 106 which are attached to the side walls 26, 30 of the pickup bed 28. The roll up tonneau cover 104 may be opened or closed by sliding it along the rails 106 as shown by the bi-directional arrow. By virtue of the attachment to the interior side of the side walls 26, 30, no part of the roll up tonneau cover 104 affects the top rail 36 of the side walls 26, 30. The sport bar 10 mounts to the top rails 36 of the side walls 26, 30 of the pickup bed 28. When the sport bar is used with the roll up tonneau cover 104, the removable end panel 56 may be attached to the mounting brackets 18, 20.

The above description is given by way of example, and not limitation. Given the above disclosure, one skilled in the art could devise variations that are within the scope and spirit of the invention disclosed herein, including various ways of configuring the top plate, side wall, and base plate of the mounting brackets. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A sport bar mounting system, comprising:
a first mounting bracket configured to attach to a top rail of a first side wall, the first mounting bracket comprising a generally C shaped elongate channel with the interior of the channel sized to receive a tonneau cover therein; and
a second mounting bracket configured to attach to a top rail of a second opposing side wall, the second mounting bracket comprising a generally C shaped elongate channel with the interior of the channel sized to receive a tonneau cover therein;
wherein the first mounting bracket and the second mounting bracket are mirror images of one another.

2. The sport bar mounting system of claim 1, wherein the first mounting bracket and second mounting bracket each comprise a base plate.

3. The sport bar mounting system of claim 1, wherein each base plate is countersunk where a bolt attaches the base plate to the top rail.

4. The sport bar mounting system of claim 1, wherein the first mounting bracket further comprises a top plate, and a side wall, and the second mounting bracket further comprises a top plate, and a side wall.

5. The sport bar mounting system of claim 4, further comprising an end panel attached to the top plate of the first mounting bracket, and a second end panel attached to the top plate of the second mounting bracket.

6. The sport bar mounting system of claim 4, wherein the side wall of the first mounting bracket is perpendicular to the top plate and base plate of the first mounting bracket, and the side wall of the second mounting bracket is perpendicular to the top plate and base plate of the second mounting bracket.

7. The sport bar mounting system of claim 4, wherein a joint between the side wall and the top plate of the first mounting bracket forms an obtuse angle and a joint between the side wall and base plate of the first mounting bracket forms an acute angle, and a joint between the side wall and the top plate of the second mounting bracket forms an obtuse angle and a joint between the base plate and the side wall of the second mounting bracket forms an acute angle.

8. The sport bar mounting system of claim 1, further comprising an end cap on one end of the first mounting bracket, and an end cap on one end of the second mounting bracket.

9. The sport bar mounting system of claim 1, further comprising a gasket under each of the base plates.

10. The sport bar mounting system of claim 9, further comprising at least one spacer above each of the top plates.

11. The sport bar mounting system of claim 10, wherein a hole in each of the spacers and a slot in each of the top plates align to form a common bore.

12. The sport bar mounting system of claim 11, wherein a hardware hole in each of the gaskets and a hardware hole in each of the base plates align to form a common bore.

13. A mounting bracket, comprising:
a base plate comprising a plurality of hardware holes, a rear edge and an edge;
a side wall connected along a first edge to the edge of the base plate, and comprising a second edge and a rear taper; and
a top plate comprising a rear edge, at least two slots and an edge, connected along the edge to the second edge of the side wall;
wherein the top plate is cantilevered over the base plate, such that the top plate and the base plate are substantially parallel, and the taper defines a distance between the rear edge of the top plate, and the rear edge of the base plate.

14. The mounting bracket of claim 13, further comprising a front end cap.

15. The mounting bracket of claim 13, wherein the side wall of the first mounting bracket is perpendicular to the top plate and base plate of the first mounting bracket, and the side wall of the second mounting bracket is perpendicular to the top plate and base plate of the second mounting bracket.

16. The mounting bracket of claim 13, wherein a joint between the side wall and the top plate of the first mounting bracket forms an obtuse angle and a joint between the side wall and base plate of the first mounting bracket forms an acute angle, and a joint between the side wall and the top plate of the second mounting bracket forms an obtuse angle and a joint between the base plate and the side wall of the second mounting bracket forms an acute angle.

17. The mounting bracket of claim 13, further comprising an end panel.

18. The mounting bracket of claim 13, wherein the hardware holes comprise countersinking.

19. The mounting bracket of claim 13, wherein one of the at least two slots is a longitudinal slot.

20. The mount bracket of claim 13, wherein one of the at least two slots is a perpendicular slot.
